(19) United States
(12) Patent Application Publication
(10) Pub. No.: US 2009/0234838 A1
(43) Pub. Date: Sep. 17, 2009

(54) SYSTEM, METHOD, AND/OR APPARATUS FOR SUBSET DISCOVERY

(75) Inventor: Xin Li, Sunnyvale, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: YAHOO! INC., Sunnyvale, CA (US)

(21) Appl. No.: 12/049,104

(22) Filed: Mar. 14, 2008

(51) Int. Cl. G06F 7/06; G06F 17/30

(52) U.S. Cl. 707/5; 707/E17.017

(57) ABSTRACT

Embodiments of methods, apparatuses, devices and/or systems associated with subset discovery are disclosed.

### FIELD

Embodiments of the claimed subject matter relate to the field of subset discovery, and more specifically to subset discovery in relation to search queries.

### BACKGROUND

In light of the large amount of content and/or information available on the internet it may be advantageous to have a way to organize and/or search for one or more areas of interest. For example, a user may use one or more Internet search engines to identify potentially relevant content, such as by searching based on one or more key words related to an area of interest. Results from one or more search engines may be organized according to one or more formulas based on a determined relevancy of a particular page to the one or more key words. For additional example, it may be desirable for a search engine to modify search results, at least in part to reduce redundant results from being displayed to a user. However, given the large amount of content and/or information available new solutions for organizing and/or modifying search results may be advantageous.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a flowchart of a process or method in accordance with at least one embodiment;

FIG. 2 is a flowchart of another process or method in accordance with at least one embodiment; and

FIG. 3 is a schematic diagram of a system in accordance with at least one embodiment.

### DETAILED DESCRIPTION

In the following detailed description, numerous specific details are set forth to provide a thorough understanding of the claimed subject matter. However, it will be understood by those skilled in the art that claimed subject matter may be practiced without these specific details. In other instances, methods, procedures, and/or components that would be known by one of ordinary skill have not been described in detail so as not to obscure the claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment. Furthermore, the particular features, structures, and/or characteristics may be combined in one or more embodiments.

Unless specifically stated otherwise, as apparent from the following discussion, it is appreciated that throughout this specification discussions utilizing terms such as “processing,” “computing,” “calculating,” “comparing,” “selecting,” “forming,” “enabling,” “inhibiting,” “identifying,” “initiating,” “querying,” “obtaining,” “hosting,” “maintaining,” “representing,” “modifying,” “updating,” “receiving,” “transmitting,” “storing,” “authenticating,” “authorizing,” “hosting,” “determining,” “displaying,” and/or the like refer to the actions and/or processes that may be performed by a computing platform, such as a computer or a similar electronic computing device, that manipulates and/or transforms data represented as physical, electronic and/or magnetic quantities and/or other physical quantities within the computing platform's processors, memories, registers, and/or other information storage, transmission, reception and/or display devices. Accordingly, a computing platform refers to a system or a device that includes the ability to process and/or store data in the form of signals. Thus, a computing platform, in this context, may comprise hardware, software, firmware and/or any combination thereof. Further, unless specifically stated otherwise, a process as described herein, with reference to flow diagrams or otherwise, may also be executed and/or controlled, in whole or in part, by a computing platform.

Through the use of the Internet, users can access a large quantity of information on a variety of topics. However, under some circumstances it may be difficult for a user to locate information they are interested in. To address this problem, a mechanism known as a “search engine” may be employed to index a large number of web pages and provide an interface that may be used to search the indexed information, for example, by entering key words or phases.

A search engine may, for example, include or otherwise employ on a “crawler” (also referred to as “crawler”, “spider”, “robot”) that may “crawl” the Internet in some manner to locate web documents. Upon locating a web document, the crawler may store the document's URL, and possibly follow any hyperlinks associated with the web document to locate other web documents.

A search engine may, for example, include information extraction and/or indexing mechanisms adapted to extract and/or otherwise index certain information about the web documents that were located by the crawler. Such index information may, for example, be generated based on the contents of an HTML file associated with a web document. An indexing mechanism may store index information in a database. A search engine may provide a search tool that allows users to search the database. The search tool may include a user interface to allow users to input or otherwise specify search terms, such as keywords, and receive and/or view search results. A search engine may present the search results in a particular order, such as according to a ranking scheme and/or a ranking process, for example.

Under some circumstances it may be desirable for the search engine to modify one or more search results, such as by removing one or more at least in part redundant search results from results that may be displayed to a user. For example, at a website, such as a search engine or an “answers” web site, where information may be categorized or organized into one or more groups, it may be desirable to determine whether one or more of the groups of search results are subsets of other groups of search results. In the example of an “answers” web site, information may be organized into groups, such as into groups of answers to one or more questions. In this example, it may be desirable to determine if the information in a first group of answers is already included in another group of answers, such as when the first group of answers is a subset of another group of answers. It may also be desirable to determine whether potential new groups, such as a group of answers to a new question, are subsets of already existing groups. For example, a first group, or data set, may include a set of information or elements, such as one or more URL's. In an embodiment, it may be beneficial to determine whether the first group is a subset of one or more existing groups so that a user may be presented with less redundant or more accurate search results. For example, an application program may compare elements of the first group to elements of one or more existing groups to determine if the first group is a subset of any of the one or more existing groups. Determining a subset relationship, as described more fully herein, may allow a search engine to present more desirable and/or organized search results to a user.

For example, in response to a search query a search engine may determine whether a first data set or grouping of search results is a subset of one or more additional data sets or groupings of search results, at least in part to reduce redundant search results displayed to a user. In an embodiment, it may be useful to remove one or more subsets, so that particular key words may point to search results including less redundancy than would otherwise be achieved. It may also be desirable to determine whether a particular data set is a subset of another data set, and may be removed from search results displayed to a user to reduce redundancy in the search results. It may also be desirable to determine whether a particular data set is a subset of another data set without actually comparing the particular data set to all of the other data sets. Accordingly, it may be desirable to identify one or more data sets as potential candidates for having a subset/superset relationship as part of the determining and/or modifying process. It should be noted, however, that these are merely illustrative examples relating to reordering search results and that claimed subject matter is not limited in these regards.

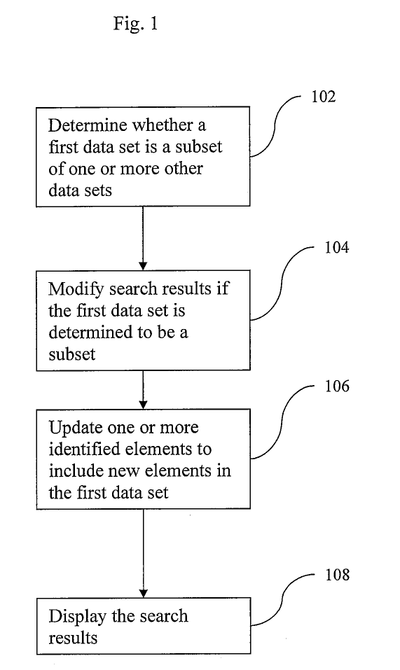

FIG. 1 is a flowchart of a process or method 100 in accordance with at least one embodiment. With regard to FIG. 1, an application program, such as one or more portions of a search engine, for example, may respond to one or more queries. For example, a user employing a graphical interface (GUI) may initiate a query by entering one or more key words into the GUI. The search engine, at least in part in response to the initiated query, may produce one or more search results. With regard to box 102, the application program may determine whether a first data set, such as one or more portions of the generated search results, is a subset of one or more other data sets, such as one or more other portions of the generated search results, for example. As used herein the term “subset” may comprise a data set, such as one or more groupings of search results, for example, that may comprise one or more elements, such as one or more URLs, for example. In some circumstances, the one or more elements of the data set may be the same as one or more elements of one or more additional data sets and/or the same as at least a portion of the elements of one or more additional data sets. If all of the elements of a first data set are include in a second data set, then the first data set may be a subset of the second data set, because the first data set does not include any additional or new elements. As used herein, “elements” of a set or subset may comprise one or more pieces of information or data, such as one or more documents, URL's or the like. For example, if a first data set includes the elements A, B, C, and D and a second data set also includes the elements A, B, C, and D then the first data set may be considered a subset of the second data set. For an additional example, if elements A, B, C, and D make up a first data set and elements A, B, C, D, and E make up a second data set, then the first data set is a subset of the second data set.

In at least one embodiment, an application program may determine whether said first data set is a subset of one or more additional data sets based on a comparison of one or more elements in the first data set with one or more identified elements of the one or more additional data sets. In an embodiment, one or more elements of the one or more additional data sets may have previously been identified and/or stored, such as in memory coupled to a computing platform. For example, one or more elements, such as URLs, associated with one or more data sets, such as categories of information, questions, answers, and/or queries, may have been previously identified and/or stored in memory. In an embodiment, the application program may compare elements of the first data set with the stored identified elements of the one or more additional data sets to determine whether the first data set is a subset of any of the one or more additional data sets. For example, the application program may locate one or more elements in the first data set, such as by looking up one or more of the elements up in the first data set in a database and/or table of some sort, to determine whether the elements are present in one or more additional data sets. The application program may, under some circumstances, proceed to compare the first data set to additional data sets that have elements in common with the first data set. For example, if the application program determines that a first element of the first data set is also included in one or more additional data sets, then the application program may compare the first data set to a first one of the one or more additional data sets that also include the first element from the first data set. The application program may also, under some circumstances, such as if the first data set is not determined to be a subset of the first one of the one or more additional data sets, compare the first data set to a second one of the one or more additional data sets. In at least one embodiment, this process may continue to compare the first data set to subsequent additional data sets having elements in common with the first data set until it is determined that the first data set is a subset of at least one of the one or more additional data sets or until it is determined that the first data set is not a subset of any of the one or more additional data sets. In at least one embodiment, the application program may determine a length for one or more of the additional data sets that include the first element from the first data set, such as by determining a number of elements in the one or more additional data sets. The application may then compare the first data set to the one or more additional data sets in an order, such as by an ascending and/or a descending length of the one or more additional data sets, for example.

With regard to box 104, the application program may modify generated search results if is determined that a first data set in the generated search results is a subset of the one or more additional data sets in the generated search results. For example, if the first data set is determined to be a subset of one of the one or more additional data sets, then the application program may remove the first data set from the search results, and/or otherwise modify the search results to reflect that the first data set is a subset of another data set at least in part to reduce redundancy in any search results that are transmitted or displayed to a user. With regard to box 106, the application program may further update the stored one or more identified elements to include any new identified element in the first data set. For example, if the first data set includes one or more elements that had not been previously identified the application program may modify the stored one or more identified elements to include any elements that had not been previously identified and associate those elements with the first data set. In this example, if the first data set also includes one or more elements that had been previously identified, the application program may further modify the stored one or more identified elements so that the previously identified elements in the first data set are associated with the first data set in addition to one or more of the additional data sets. In an embodiment, this results in data sets that are not subsets being associated with each of their elements in the stored one or more identified elements. In addition, the stored one or more identified elements are associated with each data set which includes that element. In an embodiment, if the first data set includes at least one element that had not been previously identified then the application may not to compare the first data set to any of the one or more additional data sets. For example, if the first data set includes a new element then the first data set is not a subset of any of the one or more additional data sets. With regard to box 108, the application program may generate a display of the search results, such as for display in a GUI to a user, for example.

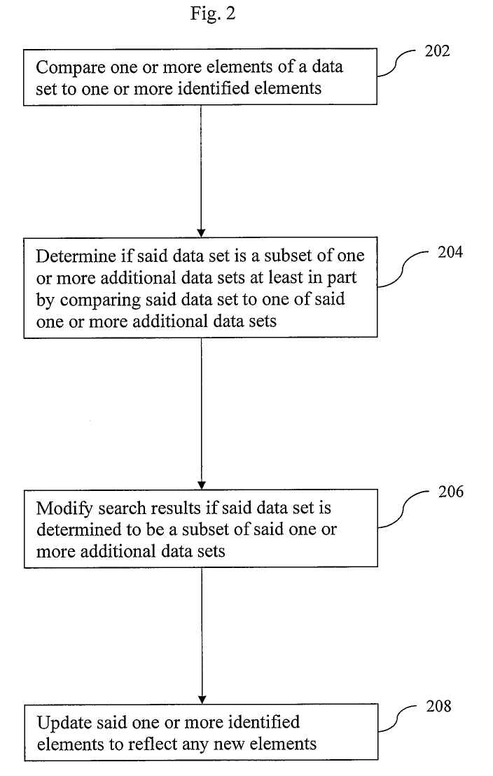

FIG. 2 is a flowchart of another process or method 200 in accordance with at least one additional embodiment. With regard to box 202, an application program may compare one or more elements of a first data set to one or more identified elements, such as one or more identified elements stored in memory couple to a computing platform, for example. In an embodiment, the stored one or more identified elements may comprise one or more identified search results associated with one or more additional sets of data, such as one or more questions and/or categories of data, for example. With regard to box 204, the application program may determine whether the first data set is a subset of any of the one or more additional data sets, such as by comparing the first data set to at least one of the one or more additional data sets. The application program may, under some circumstances, compare the first data set to subsequent ones of the one or more additional data sets until it is determined whether or not the first data set is a subset of any of the one or more additional data sets.

With regard to box 206, the application program may further modify search results if the first data set is determined to be a subset of any of the one or more additional data sets. For example, the application program may remove the first data set from any generated search results and/or otherwise modify the search results to reflect that the first data set is a subset of at least one of the one or more additional data sets. For example, the application program may position the first data set in a manner to indicate that the first data set has a subset relationship with one of the one or more additional data sets. With regard to box 208, the application program may update the stored one or more identified elements to reflect any new elements from the first data set. For example, if the first data set includes an element that had not previously been identified the application program may update the one or more identified elements to include the not previously identified element and associate that element with the first data set. In this example, if the first data set also includes one or more elements that had been previously identified the application program may further modify the stored one or more identified elements so that the previously identified elements in the first data set are associated with the first data set in addition to one or more of the additional data sets. In an embodiment, this results in data sets that are not subsets being associated with each of their elements in the stored one or more identified elements. In addition, the stored one or more identified elements are associated with each data set which includes that element. In an embodiment, if the first data set includes at least one element that had not been previously identified then the application may not to compare the first data set to any of the one or more additional data sets. For example, if the first data set includes a new element then the first data set is not a subset of any of the one or more additional data sets. In at least one embodiment, updating the one or more identified elements may comprise creating a new database or table entry for the new element and associating the created table entry with the first data set.

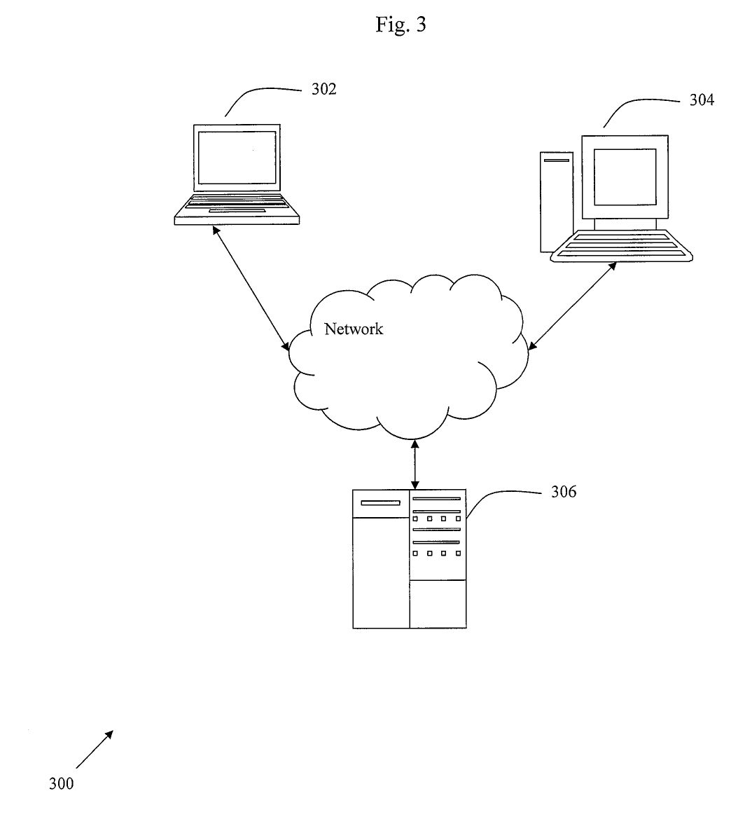

FIG. 3 is a schematic diagram of a system 300 in accordance with at least one embodiment. With regard to FIG. 3, a user may initiate a search query, such as a search query for answers to one or more questions, for example, using a graphical user interface (GUI) in an application program, such as a web browser, executing on a computing platform, such as computing platforms 302 and/or 304, for example. The query may be transmitted via a network to one or more search engines, such as one or more search engines executing on a computing platform, such as computing platform 306, for example. The search engine may generate one or more search results based, at least in part, on the user initiated query. An application program, which may, under some circumstances be a subroutine or module of the search engine, or may, under some circumstance, be an independent application program, may analyze the generated search results at least in part to determine if any of the search results are subsets of one or more additional data sets.

For example, the generated search results may include a first data set, including one or more elements, such as one or more search results. The application program may compare the one or more element of the first data set to one or more identified elements. In an embodiment, the one or more identified element may be stored in memory coupled to and/or in communication with computing platform 306, and may comprise one or more data base entries, one or more table entries, and/or one or more hash table entries, for example. Furthermore, the one or more identified element may be associated with the one or more additional data sets. In an embodiment, the application program may locate one or more of the elements from the first data set to determine if those elements have been associated with the one or more additional data sets. If an element of the first data set has been associated with one of the one or more additional data sets then the application program may determine if the first data set is a subset of that additional data set. In an embodiment, if the first data set includes at least one element that had not been previously identified the application may not to compare the first data set to any of the one or more additional data sets. For example, if the first data set includes a new element then the first data set is not a subset of any of the one or more additional data sets.

For example, the application program may, under some circumstances, determine all of the one or more additional data sets that have at least one element in common with the first data set. In one embodiment, the application program may also determine a length for each of the one or more additional data sets, such as by determining a number of elements in each of the one or more additional data sets having at least one element in common with the first data set. The application program may compare the first data set to one or more of the additional data sets with at least one element in common in sequential order, such as based on ascending and/or descending length of the one or more additional data sets, for example. If, based on the comparisons, it is determined that the first data set is a subset of any of the one or more additional data sets that the application program may modify the generated search results, such as by removing the first data set and/or otherwise indicating that the first data set is a subset of one or more of the one or more additional data sets.

In addition, the application program may update the one or more identified elements to include any new elements from the first data set. For example, if the first data set includes one or more new elements the application program may update the table or database where the one or more identified elements are stored to include a new entry for the new elements from the first data set and associate those new elements with the first data set. In this example, if the first data set also includes one or more elements that had been previously identified the application program may further update the table of database where the one or more identified elements are stored so that the previously identified elements in the first data set are associated with the first data set in addition to one or more of the additional data sets. In an embodiment, this results in data sets that are not subsets being associated with each of their elements in the table or database where the one or more identified elements are stored. In addition, the stored one or more identified elements are associated with each data set which includes that element. The application program may then generate a display and transmit the generated display to a computing platform, such as computing platforms 302 and/or 304 for display to a user.

In the preceding description, various aspects of claimed subject matter have been described. For purposes of explanation, specific numbers, systems and/or configurations were set forth to provide a thorough understanding of the claimed subject matter. However, it should be noted that although various embodiments have been described in terms of the above example, the above examples were merely illustrative example relating to search results and that claimed subject matter is not limited in these regards. However, it should be apparent to one skilled in the art having the benefit of this disclosure that claimed subject matter may be practiced without the specific details. In other instances, features that would be understood by one of ordinary skill were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method comprising:
determining whether a first data set is a subset of one or more additional data sets based, at least in part, on a comparison of one or more elements of said first data set with one or more identified elements of said one or more additional data sets, wherein said one or more identified elements are stored in memory coupled to a computing platform;
modifying search results if it is determined that said data set is a subset of said one or more additional data sets; and
updating said one or more identified elements to include new elements in said first data set not previously identified.

2. The method of claim 1, wherein said determining comprises comparing the first data set to one of said one or more additional data sets, wherein said one of said one or more additional data sets has at least one element in common with said first data set.

3. The method of claim 2, wherein said determining further comprises comparing the first data set to a second one of said one or more additional data sets, wherein said second one of said one or more additional data sets has at least one element in common with said first data set.

4. The method of claim 1, wherein said search results comprise one or more categories of answers.

5. The method of claim 1, wherein said search results comprise one or more social searching categories.

6. The method of claim 1, and further comprising: displaying said search results, wherein the displayed results comprise one or more data sets that have been determined not to be a subset of said one or more additional data sets.

7. An article comprising: a storage media having instructions stored therein, wherein said instructions, if executed by a computing platform, are adapted to enable a computing platform to:
determine whether a first data set is a subset of one or more additional data sets based, at least in part, on a comparison of one or more elements of said first data set with one or more identified elements of said one or more additional data sets;
modify search results if it is determined that said data set is a subset of said one or more additional data sets; and
update said one or more identified elements to include new elements in said first data set not previously identified.

8. The article of claim 7, wherein said instruction, if executed by a computing platform, are further adapted to enable said computing platform to compare the first data set to one of said one or more additional data sets, wherein said one of said one or more additional data sets has at least one element in common with said first data set.

9. The article of claim 8, wherein said instruction, if executed by a computing platform, are further adapted to enable said computing platform to compare the first data set to a second one of said one or more additional data sets, wherein said second one of said one or more additional data sets has at least one element in common with said first data set.

10. The article of claim 7, wherein said search results comprise one or more categories of answers.

11. The article of claim 7, wherein said search results comprise one or more social searching categories.

12. The article of claim 7, wherein said instruction, if executed by a computing platform, are further adapted to enable said computing platform to display said search results, wherein the displayed results comprise one or more data sets that have been determined not to be a subset of said one or more additional data sets.

13. A system comprising:
a computing platform operable to determine whether a first data set is a subset of one or more additional data sets based, at least in part, on a comparison of one or more elements of said first data set with one or more identified elements of said one or more additional data sets;
said computing platform operable to modify search results if it is determined that said data set is a subset of said one or more additional data sets; and
said computing platform operable to update said one or more identified elements to include new elements in said first data set not previously identified.

14. The system of claim 13, wherein said computing platform is operable to determine whether said first data set is a subset of one or more additional data sets at least in part by comparing the first data set to one of said one or more additional data sets, wherein said one of said one or more additional data sets has at least one element in common with said first data set.

15. The system of claim 14, wherein said computing platform is operable to determine whether said first data set is a subset of one or more additional data sets at least in part by comparing the first data set to a second one of said one or more additional data sets, wherein said second one of said one or more additional data sets has at least one element in common with said first data set.

16. The system of claim 13, wherein said search results comprise one or more categories of answers.

17. The system of claim 13, wherein said search results comprise one or more social searching categories.

18. The system of claim 13, wherein said computing platform is further operable to generate a display of said search results, wherein said display comprises one or more data sets that have been determined not to be a subset of said one or more additional data sets.

19. A method comprising:
comparing one or more elements of a data set to one or more identified elements associated with one or more additional data sets, wherein said one or more identified elements are stored in memory coupled to a computing platform;
determining if said data set is a subset of said one or more additional data sets at least in part by comparing said data set to one of said one or more additional data sets, wherein said one of said one or more additional data sets has at least one element in common with said data set; and
modifying search results if it is determined that said data set is a subset of said one of said one or more additional data sets.

20. The method of claim 19, and further comprising;
updating said one or more identified elements to reflect any new elements not previously identified.

21. The method of claim 20, and further comprising:
comparing said data set to a second one of said one or more additional data sets, wherein said second one of said one or more additional data sets has at least one element in common with said data set; and
modifying search results if it is determined that said data set is a subset of said one of said one or more additional data sets.

22. The method of claim 19, wherein said search results comprise one or more categories of answers.

23. The method of claim 19, wherein said search results comprise one or more social searching categories.

24. The method of claim 19, and further comprising: displaying said search results, wherein the displayed results comprise one or more data sets that have been determined not to be a subset of any additional data sets.
